(19) United States
(12) Patent Application Publication
(10) Pub. No.: US 2014/0232599 A1
(43) Pub. Date: Aug. 21, 2014

(54) Method and devices for unambiguously identifying an object

(71) Applicant: Deutsches Zentrum fuer Luft- und Raumfahrt e. V., Koeln (DE)

(72) Inventors: Joerg BEHRENS, Bremen (DE); Christoph VON KOPYLOW, Wilistedt (DE); Collin DANKWART, Bremen (DE); Claas FALLDORF, Bremen (DE)

(73) Assignee: Deutsches Zentrum fuer Luft- und Raumfahrt e. V., Koeln (DE)

(21) Appl. No.: 14/185,371

(22) Filed: Feb. 20, 2014

(30) Foreign Application Priority Data
Feb. 21, 2013 (DE) 10 2013 101 730.4

(51) Int. Cl. G01S 13/06; G01S 17/06

(52) U.S. Cl. CPC G01S 13/06; G01S 17/06
USPC 342/385; 356/614

(57) ABSTRACT

The invention relates to a method for unambiguously identifying an object (1, 2, 3) having one or both of the following features a), b):
a) at least one unambiguous identification means (4, 5, 6) is arranged on or in an object (1, 2, 3) that is in the form of a space projectile (1, 2); a transmission signal (11) having electromagnetic waves is sent from a transmission station (7) to the identification means (4, 5, 6) of the space projectile (1, 2) that is in space (15); an identification signal (12) having electromagnetic waves that are returned by the identification means (4, 5, 6) of the space projectile (1, 2) in response to the transmission signal (11) is received in a reception station (9); the space projectile (1, 2) is unambiguously identified using the identification signal (12);
b) at least one unambiguous identification means (4, 5, 6) that is set up for directional reflection of an identification signal (12) in response to a transmission signal (11) with a defined reflection direction is arranged on an object (1, 2, 3); a transmission signal (11) having electromagnetic waves is sent from a transmission station (7) to the identification means (4, 5, 6) of the object (1, 2, 3); an identification signal (12) that is directionally reflected by the identification means (4, 5, 6) of the object (1, 2, 3) in response to the transmission signal (11) is received in a reception station (9); the object (1, 2, 3) is unambiguously identified using the identification signal (12).

The invention also relates to an identification means for fitting to an object that is to be identified, and also to an object having such an identification means and to a space projectile having such an identification means. The invention also relates to a system that allows identification of an object.

The invention relates to a method for unambiguously identifying an object according to claim 1. The invention also relates to an identification means for fitting to an object that is to be identified according to claim 5, and also to an object having such an identification means according to claim 13 and to a space projectile having such an identification means according to claim 14. The invention also relates to a system according to claim 15 that allows identification of an object.

An “object” within the meaning of the present patent application is fundamentally understood to mean any article that needs to be unambiguously identified. Objects within the meaning of the present patent application may also be living beings, e.g. animals.

The unambiguous identification of an object is important in many areas of engineering. The unambiguous identification of an object does not just involve establishing whether an object is existent or in what physical position an object is located but rather additionally involves establishing what object is involved in detail. Such unambiguous identification is performed for aircraft, e.g. by a transponder that is carried in the aircraft. The unambiguously identified aircraft can then be attributed current spatial coordinates for the aircraft in an airspace monitoring system, said spatial coordinates being ascertained by radar monitoring or on the basis of data from a GPS receiver that is carried in the airplane, for example. The equipping of objects with transponders is infeasible in many cases on account of the associated costs.

A widely used method for unambiguously identifying objects also involves the object being provided with a barcode plate and being scanned with a laser scanner for the purpose of identification, e.g. what are known as scanner registers in retail. This method is suitable only for spanning short distances, i.e. the object to be identified needs to be taken past relatively close to the laser scanner.

The invention is based on the object of specifying possibilities for unambiguously identifying an object over relatively great distances that are simple and inexpensive to implement. In particular, the aim is also to allow identification over long ranges, e.g. for objects in space.

This object is achieved according to claim 1 by a method for unambiguously identifying an object having one or both of the following features a), b):
a) at least one unambiguous identification means is arranged on or in an object that is in the form of a space projectile; a transmission signal having electromagnetic waves is sent from a transmission station to the identification means of the space projectile that is in space; an identification signal having electromagnetic waves that are returned by the identification means of the space projectile in response to the transmission signal is received in a reception station; the space projectile is unambiguously identified using the identification signal;
b) at least one unambiguous identification means that is set up for directional reflection of an identification signal in response to a transmission signal with a defined reflection direction is arranged on an object; a transmission signal having electromagnetic waves is sent from a transmission station to the identification means of the object; an identification signal that is directionally reflected by the identification means of the object in response to the transmission signal is received in a reception station; the object is unambiguously identified using the identification signal.

The invention has the advantage that simple and rapid unambiguous identification is possible even for objects that are at a relatively great range from the transmission station or the reception station. Thus, the invention can be readily used to unambiguously identify objects that are in space from Earth, at least in the near-Earth region, e.g. in an orbit around the earth. The invention can therefore be used to unambiguously identify any space projectiles that are provided with an unambiguous identification means according to the invention. By way of example, it is possible to identify space projectiles such as satellites, rockets, jettisoned rocket stages and the like. This allows precise information to be obtained about objects that are in space. Data obtained therefrom can then be used to provide services, for example, such as warning of potential collisions between objects or warning of the reentry of space debris in the atmosphere. These data can be stored in a dedicated catalog, for example, and made available to users with an interest.

In order to allow unambiguous identification, the object needs to be provided with an unambiguous identification means. For this purpose, the identification means has an unambiguous identifier, e.g. a once-only allocated number, a once-only allocated code or any once-only allocated graphical pattern. A database is used to store an association between the unambiguous identifier, which can be transmitted with the identification signal, and the object on which the identification means having the unambiguous identifier is fitted.

The invention allows unambiguous identification of an object by means of an unambiguous identification means. In this case, the identification means may be unambiguous in respect of its allowing the unambiguous identification of objects of the same design or series of an article, for example. The identification means may also be designed to uniquely identify an object, i.e. the identification means has a dedicated unique identifier for each object, similar to a goods code or a motor vehicle registration.

The transmission station and/or the reception station may in this case be situated on the ground, for example, or aboard a ship or an aircraft or a land vehicle. The transmission station and the reception station do not necessarily need to be at the same point. According to an advantageous development of the invention, the transmission station and the reception station are aggregated into a combined identification station, as a result of which the transmission station and the reception station are always at the same location.

The unambiguous identification means used may be particularly an identification means that is set up for directional reflection of an identification signal in response to a transmission signal. Such an identification means with directional reflection avoids undesirable signal scatter and hence power losses in the reflected signal. This is assured by the directivity of the identification means. The directivity allows long ranges to be spanned when identifying the object, particularly ranges from Earth into space and back.

In particular, an identification means can be used that has a reflection direction that is precisely the opposite of the direction in which the transmission signal is radiated onto the identification means. This has the advantage that the identification signal can be received again at the same location from which the transmission signal was sent. By way of example, the identification means may be designed in the manner of a cat's eye, as are used for road markings, or, in order to produce the directional reflection, may have a prism arrangement or a corresponding surface structure, as used for reflector materials, for example. In particular, the identification means may be in the form of a retroreflector. By way of example, the unambiguous identification may then take place such that the retroreflector has a combination of color filters, as a result of which the identification signal has a plurality of light wavelengths that are used for coding an unambiguous identifier. In this way, an individual frequency combination of the light is reflected back for each object that is to be identified.

The invention advantageously allows the object to be identified even at long ranges between the object and the transmission and reception station, e.g. at ranges of more than 50 m. Depending on the embodiment of the invention, it is also possible to span ranges in the region of kilometers up to hundreds of kilometers.

Said identification means with the directional reflection is suitable not only for identifying space projectiles but also for identifying objects within the earth's atmosphere, such as land vehicles, ships, aircraft or living beings.

According to an advantageous development of the invention, at least one identification means of the type described in even more detail below is arranged on or in the object. It is also possible for a plurality of identical identification means, i.e. identification means with an identical unambiguous identifier, to be arranged at various points on the outer surface of the object. This has the advantage that rapid identification of the object is possible even for different spatial orientations or attitudes of the object. Wobbling objects can also be unambiguously identified rapidly and safely by these means.

According to an advantageous development of the invention, electromagnetic waves in the form of microwaves and/or light are used as the transmission signal. By way of example, the transmission signal may be a radar signal or the light signal from a laser. The returned identification signal may likewise be a microwave and/or light signal.

According to an advantageous development of the invention, a plurality of identification means, which may be in the same or different form, are arranged on or in the object in accordance with a prescribed pattern that is unambiguously associated with the object. The unambiguous identification of the object is then effected not or not just using a particular unambiguous identifier for a single identification means but rather by the pattern that is unambiguously associated with the object and that is produced by the combination of the plurality of identification means. By way of example, it is thus possible for a plurality of identification means, which return identification signals of different frequency, to be arranged on the object in the manner of a binary code.

The object cited at the outset is furthermore achieved according to claim 5 by an identification means for fitting to an object that is to be identified, which is set up for directional reflection of an identification signal in response to a transmission signal with a defined reflection direction, wherein the identification signal is suitable for unambiguously identifying the object.

According to an advantageous development of the invention, the identification means is a passive identification means, particularly an identification means that produces the identification signal without a power supply. This has the advantage that the identification means behaves in an electrically neutral manner and there are no problems to be feared on account of interactions with electrical components. The identification means is therefore comprehensively compatible with ENC. In addition, the identification means can be used autonomously, e.g. can be fitted to the object in the form of a sticker. A further advantage is that no wiring is necessary. Furthermore, such identification means have a very long life and little sensitivity to ageing. In addition, they can be provided inexpensively.

According to an advantageous development of the invention, the identification means has or comprises one or more refractive or diffractive optical elements. A combination of refractive and diffractive optical elements is also advantageous. Unambiguous identifiers for an object can be realized by means of refractive and/or diffractive elements in a comparable manner to that explained previously for the retroreflectors. This provides further options for producing the unambiguous identification of an object by means of the identification means.

According to an advantageous development of the invention, the identification means has frequency filtering means that convert a frequency spectrum for the transmission signal into a frequency or frequency combination for the identification signal, which frequency or frequency combination is unambiguously associated with the object. The multiplicity of frequencies or frequency combinations for the identification signal that are able to be distinguished using current engineering thereby allows a multiplicity of identifiers that are distinguishable, which means that a large number of objects are each unambiguously identifiable as a result.

According to an advantageous development of the invention, the identification means is in the form of patterning, particularly in the form of micropatterning, introduced into the outer surface of the object to be identified, in the form of a film applied to the outer surface of the object to be identified or in the form of a lacquer or other coating applied to the outer surface of the object to be identified. The patterning introduced into the outer surface can be impressed or engraved, for example. This allows the provision of identification means that can readily be fitted to various objects that are in totally different embodiments and that are lightweight, inexpensive and have a long life.

According to an advantageous development of the invention, the identifications means has or comprises one or more color filters. This is particularly advantageous when using light as a transmission signal. The color filter(s) allow(s) the wavelength of the light to be altered, i.e. an identification signal that has a different wavelength or light color than the transmission signal is produced on the basis of the transmission signal. When a plurality of color filters are used, it is also possible for light in a plurality of colors, i.e. in a combination of different wavelengths, to be reflected in the identification signal. Unambiguous identification of the object can then be effected by virtue of a plurality of light wavelengths being used for coding. By fitting an identification means having a particular color filter combination, an identification signal is produced that reflects back an individual frequency combination for the light for each object that is to be identified.

According to an advantageous development of the invention, the identification means has a plurality of at least semitransparent color filters arranged above one another in different colors. This likewise allows advantageous distinctions between a large number of objects.

The object cited at the outset is furthermore achieved according to claim 13 by an object that has at least one identification means of the type explained previously that allows the object to be identified remotely by means of a transmission signal that has electromagnetic waves directed at the identification means of the object by virtue of the identification means being set up to respond to the transmission signal by sending an identification signal to a reception station, which identification signal can be used to unambiguously identify the object. The object may be any object, either within the earth's atmosphere or in space.

The object is also achieved according to claim 14 by a space projectile that has at least one identification means, particularly an identification means of the type explained previously, that can remotely identify the space projectile by means of a transmission signal having electromagnetic waves that are directed at the identification means of the space projectile by virtue of the identification means being set up to respond to the transmission signal by sending an identification signal to a reception station, which identification signal can be used to unambiguously identify the object.

The object cited at the outset is furthermore achieved according to claim 15 by a system having at least one transmission station and at least one reception station, wherein the system is set up to unambiguously identify an object to be identified that is provided with at least one unambiguous identification means by carrying out a method of the type explained at the outset.

According to an advantageous development of the invention, the transmission station has at least one laser that emits the transmission signal. A laser can be used to identify even objects at a long range from the transmission station, e.g. to identify space projectiles from the earth. According to an advantageous development of the invention, the transmission station has at least one pulsed laser that emits the transmission signal. This has the advantage that a transmission signal having relatively high intensity can be provided, which means that even longer ranges between the transmission station and the object to be identified can be spanned.

The invention is explained in more detail below using exemplary embodiments with reference to a drawing.

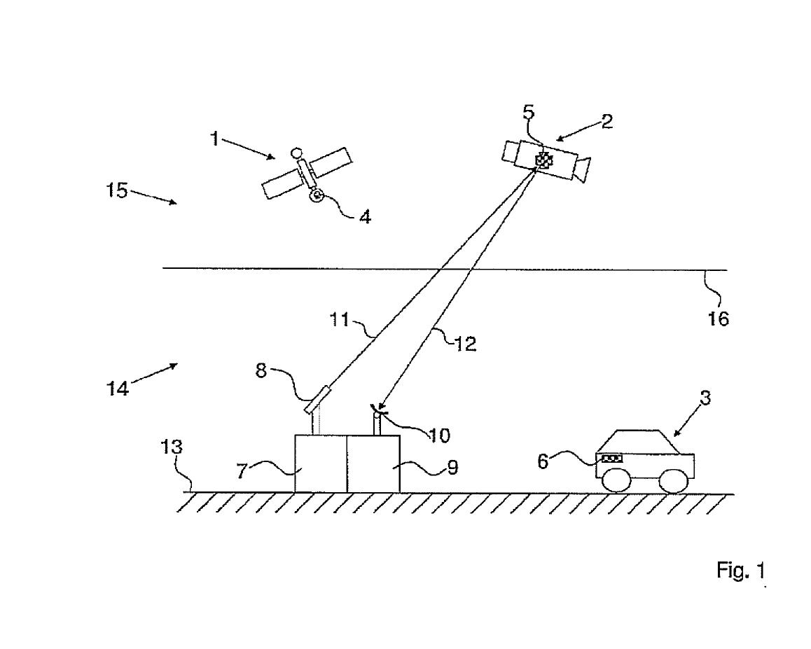

The FIG. 1 drawing shows embodiments of the invention in a schematic illustration. By way of example, it shows objects 1, 2 in space 15 in the form of space projectiles and also an object 3 to be identified that is in the region of the earth's atmosphere 14. The line 16 in FIG. 1 symbolizes the boundary between the earth's atmosphere 14 and space 15 in this case, assuming a simplified illustration for reasons of simplification.

By way of example, the space projectile 1 is a satellite and the space projectile 2 is a jettisoned rocket stage from a formerly started rocket. The object 3 may be a land vehicle, for example.

The objects 1, 2, 3 have respective unambiguous identification means 4, 5, 6, e.g. retroreflectors, which are arranged on the outer surface of the respective object.

FIG. 1 also shows a system with a transmission station 7 and a reception station 9 in an identification system. The transmission station 7 and the reception station 9 are arranged on the earth's surface 13, for example. Although not absolutely necessary, it is assumed in the example shown that the transmission station 7 and the reception station 9 are located at the same position and are physically combined to form an identification station 7, 9, for example.

The transmission station 7 has a laser 8 as a signal generator for a transmission signal 11. As the transmission signal 11, the laser 8 radiates a beam of light onto an object that is to be identified, such as the space projectile 2. The transmission signal 11 also strikes the identification means 5 of the space projectile 2, inter alia. The identification means 5 reflects an identification signal 12 to the reception station 9. By way of example, the identification signal 12 is produced by retroreflection of the transmission signal 11 and by alteration of the light wavelength, e.g. by color filters in the identification means 5. The identification signal 12 therefore contains an unambiguous identifier that is obtained from the identification means 5 and that allows unambiguous identification of the space projectile 2.

The identification signal 12 is picked up in the reception station 9 by a reception antenna 10 and is evaluated and processed further in the reception station 9.

Regular illumination of the space projectile 2 with the laser 8 also allows the path of said space projectile to be tracked, so that it is also possible for the movement of the space projectile 2 and the current position to be logged at the same time and provided in a database together with the unambiguous identification data from the space projectile 2.

In the same way, it is also possible to unambiguously identify the space projectile 1 and the land vehicle 3 by virtue of the transmission signal 11 from the laser being directed at these objects 1, 3 or the identification means 4, 6 thereof. This particularly provides a distinction between the objects 1, 2, 3 and also unambiguous recognizability of the objects 1, 2, 3.

1. A method for unambiguously identifying an object having one or both of the following features a), b):
a) at least one unambiguous identification means is arranged on or in an object that is in the form of a space projectile; a transmission signal having electromagnetic waves is sent from a transmission station to the identification means of the space projectile that is in space; an identification signal having electromagnetic waves that are returned by the identification means of the space projectile in response to the transmission signal is received in a reception station; the space projectile is unambiguously identified using the identification signal;
b) at least one unambiguous identification means that is set up for directional reflection of an identification signal in response to a transmission signal with a defined reflection direction is arranged on an object; a transmission signal having electromagnetic waves is sent from a transmission station to the identification means of the object; an identification signal that is directionally reflected by the identification means of the object in response to the transmission signal is received in a reception station; the object is unambiguously identified using the identification signal.

2. The method according to claim 1, wherein at least one identification means according to one of claims 5 to 12 is arranged on or in the object.

3. The method according to claim 1, wherein electromagnetic waves in the form of microwaves and/or light are used as the transmission signal.

4. The method according to claim 1, wherein a plurality of identification means are arranged on or in the object in accordance with a prescribed pattern that is unambiguously associated with the object.

5. An identification means for fitting to an object that is to be identified, which is set up for directional reflection of an identification signal in response to a transmission signal with a defined reflection direction, wherein the identification signal is suitable for unambiguously identifying the object.

6. The identification means according to claim 5, wherein the identification means is a passive identification means, particularly an identification means that produces the identification signal without a power supply.

7. The identification means according to claim 5, wherein the identification means has or comprises one or more retroreflectors.

8. The identification means according to claim 5, wherein the identification means has or comprises one or more refractive or diffractive optical elements.

9. The identification means according to claim 5, wherein the identification means has frequency filtering means that convert a frequency spectrum for the transmission signal into a frequency or frequency combination for the identification signal, which frequency or frequency combination is unambiguously associated with the object.

10. The identification means according to claim 5, wherein the identification means is in the form of patterning introduced into the outer surface of the object to be identified, in the form of a film applied to the outer surface of the object to be identified or in the form of a lacquer or other coating applied to the outer surface of the object to be identified.

11. The identification means according to claim 5, wherein the identification means has or comprises one or more color filters.

12. The identification means according to claim 11, wherein the identification means has a plurality of at least semitransparent color filters arranged above one another in different colors.

13. An object, wherein the object has at least one identification means according to one of claims 5 to 12 that allows the object to be identified remotely by means of a transmission signal that has electromagnetic waves directed at the identification means of the object by virtue of the identification means being set up to respond to the transmission signal by sending an identification signal to a reception station, which identification signal can be used to unambiguously identify the object.

14. A space projectile, wherein the space projectile has at least one identification means, particularly at least one identification means according to one of claims 5 to 12, that can remotely identify the space projectile by means of a transmission signal having electromagnetic waves that are directed at the identification means of the space projectile by virtue of the identification means being set up to respond to the transmission signal by sending an identification signal to a reception station, which identification signal can be used to unambiguously identify the object.

15. A system having at least one transmission station and at least one reception station, wherein the system is set up to unambiguously identify an object to be identified that is provided with at least one unambiguous identification means by carrying out a method according to one of claims 1 to 4.

16. The system according to claim 15, wherein the transmission station has at least one laser, particularly a pulsed laser, that emits the transmission signal.
